(19) United States
(12) Patent Application Publication
(10) Pub. No.: US 2022/0230418 A1
(43) Pub. Date: Jul. 21, 2022

(54) COMPUTER-IMPLEMENTED METHOD FOR TRAINING A COMPUTER VISION MODEL

(71) Applicant: Robert Bosch GmbH, Stuttgart (DE)

(72) Inventors: Christoph Gladisch, Renningen (DE); Christian Heinzemann, Ludwigsburg (DE); Matthias Woehrle, Bietigheim-Bissingen (DE)

(21) Appl. No.: 17/646,967

(22) Filed: Jan. 4, 2022

(30) Foreign Application Priority Data
Jan. 15, 2021 (DE) 10 2021 200 348.6

(51) Int. Cl. G06V 10/774; G06T 7/11; G06V 10/82; G06N 3/04; G06N 3/08; G06V 10/764

(52) U.S. Cl. CPC G06V 10/774; G06T 7/11; G06V 10/764; G06N 3/0454; G06N 3/08; G06V 10/82

(57) ABSTRACT

A computer-implemented method for training a computer vision model to characterise elements of observed scenes parameterized using visual parameters. During the iterative training of the computer vision model, the latent variables of the computer vision model are altered based upon a (global) sensitivity analysis used to rank the effect of visual parameters on the computer vision model.

### CROSS REFERENCE

The present application claims the benefit under 35 U.S.C. § 119 of German Patent Application No. DE 102021200348.6 filed on Jan. 15, 2021, which is expressly incorporated herein by reference in its entirety.

### FIELD

The present invention relates to a computer-implemented method for training a computer vision model to characterise elements of observed scenes, a method of characterising elements of observed scenes using a computer vision model, and an associated apparatus, computer program, computer readable medium, and distributed data communications system.

### BACKGROUND INFORMATION

Computer vision concerns how computers can automatically gain high-level understanding from digital images or videos. Computer vision systems are finding increasing application to the automotive or robotic vehicle field. Computer vision can process inputs from any interaction between at least one detector and the environment of that detector. The environment may be perceived by the at least one detector as a scene or a succession of scenes.

In particular, interaction may result from at least one electromagnetic source which may or may not be part of the environment. Detectors capable of capturing such electromagnetic interactions can, for example, be a camera, a multi-camera system, a RADAR or LIDAR system.

In automotive computer vision systems, systems computer vision often has to deal with open context despite being safety-critical. It is, therefore, important that quantitative safeguarding means are taken into account both in designing and testing computer vision functions.

### SUMMARY

According to a first aspect of the present invention, there is provided a computer-implemented method for training a computer vision model to characterise elements of observed scenes.

In accordance with an example embodiment of the present invention, the first method includes obtaining a visual data set of the observed scenes, selecting from the visual data set a first subset of items of visual data, and providing a first subset of items of groundtruth data that correspond to the first subset of items of visual data, the first subset of items of visual data and the first subset of items of groundtruth data forming a training data set. Furthermore, the method comprises obtaining at least one visual parameter, with the at least one visual parameter defining a visual state of at least one item of visual data in the training data set. The visual state is capable of affecting a classification or regression performance of an untrained version of the computer vision model. Furthermore, the method comprises iteratively training the computer vision model based on the training data set, so as to render the computer vision model capable of providing a prediction of one, or more, elements within the observed scenes comprised in at least one subsequent (i.e. after the current training iteration) item of visual data input into the computer vision model. During the iterative training, at least one visual parameter of the plurality of visual parameters is applied to the computer vision model, to thereby bias a subset of a latent representation of the computer vision model using the at least one visual parameter according to the visual state of the training data set input into the computer vision model during training.

The method according to the first aspect of the present invention advantageously forces the computer vision model to recognize the concept of the at least one visual parameter, and thus is capable of improving the computer vision model according to the extra information provided by biasing the computer vision model (in particular, the latent representation of the computer vision model) during training. Therefore, the computer vision model is trained according to visual parameters that have been verified as being relevant to the performance of the computer vision model.

According to a second aspect of the present invention, there is provided a computer-implemented method for characterising elements of observed scenes.

In accordance with an example embodiment of the present invention, the method according to the second aspect comprises obtaining a visual data set comprising a set of observation images, wherein each observation image comprises an observed scene. Furthermore, the method according to the second aspect comprises obtaining a computer vision model trained according to the method of the first aspect, or its embodiments.

Furthermore, the method according to the second aspect of the present invention comprises processing the visual data set using the computer vision model to thus obtain a plurality of predictions corresponding to the visual data set, wherein each prediction characterises at least one element of an observed scene.

Advantageously, a computer vision is enhanced by using a computer vision model that has been trained to also recognize the concept of the at least one visual parameter, enabling a safer and more reliable computer vision model to be applied that is less influenced by the hidden bias of an expert (e.g. a developer).

According to a third aspect of the present invention, there is provided a data processing apparatus configured to characterise at least one element of an observed scene.

The data processing apparatus comprises an input interface, a processor, a memory and an output interface.

The input interface is configured to obtain a visual data set comprising a set of observation images, wherein each observation image comprises an observed scene, and to store the visual data set, and a computer vision model trained according to the first method, in the memory.

The processor is configured to obtain the visual data set and the computer vision model from the memory. Furthermore, the processor is configured to process the visual data set using the computer vision model, to thus obtain a plurality of predictions corresponding to the set of observation images, wherein each prediction characterising at least one element of an observed scene.

Furthermore, the processor is configured to store the plurality of predictions in the memory, and/or to output the plurality of predictions via the output interface.

A fourth aspect of the present invention relates to a computer program comprising instructions which, when executed by a computer, causes the computer to carry out the first method or the second method.

A fifth aspect of the present invention relates to a computer readable medium having stored thereon one or both of the computer programs.

A sixth aspect of the present invention relates to a distributed data communications system comprising a remote data processing agent, a communications network, and a terminal device, wherein the terminal device is optionally a vehicle, an autonomous vehicle, an automobile or robot. The data processing agent is configured to transmit the computer vision model according to the method of the first aspect to the terminal device via the communications network.

Example embodiments of the aforementioned aspects disclosed herein and explained in the following description, to which the reader should now refer.

A visual data set of the observed scenes is a set of items representing either an image or a video, the latter being a sequence of images, such as JPEG or GIF images.

An item of groundtruth data corresponding to one item of visual data is a classification and/or regression result that the computer vision function is intended to output. In other words, the groundtruth data represents a correct answer of the computer vision function when input with an item of visual data showing a predictable scene or element of a scene. The term image may relate to a subset of an image, such as a segmented road sign or obstacle.

A computer vision model is a function parametrized by model parameters that upon training can be learnt based on the training data set using machine learning techniques. The computer vision model is configured to at least map an item of visual data or a portion, or subset thereof to an item of predicted data. One or more visual parameters define a visual state in that they contain information about the contents of the observed scene and/or represent boundary conditions for capturing and/or generating the observed scene. A latent representation of the computer vision model is an intermediate (i.e. hidden) layer or a portion thereof in the computer vision model.

An example embodiment of the present invention provides an extended computer vision model implemented, for example, in a deep neural-like network which is configured to integrate verification results into the design of the computer vision model. The present invention provides a way to identify critical visual parameters the computer vision model should be sensitive to in terms of a latent representation within the computer vision model. It is by means of a particular architecture of the computer vision model configured to enforce the computer vision model to recognize upon training the concept of at least one visual parameter. For example, it can be advantageous to have the computer vision model recognize the most critical visual parameters wherein relevance results from a (global) sensitivity analysis determining the variance of performance scores of the computer vision model with respect to visual parameters.

### BRIEF DESCRIPTION OF THE DRAWINGS

FIG. 1 schematically illustrates a development and verification process of a computer vision function, in accordance with an example embodiment of the present invention.

FIG. 2 schematically illustrates an example computer-implemented method according to the first aspect of the present invention for training a computer vision model.

FIG. 3 schematically illustrates an example data processing apparatus according to the third aspect of the present invention.

FIG. 4 schematically illustrates an example distributed data communications system according to the sixth aspect of the present invention.

FIG. 5 schematically illustrates an example of a computer-implemented method for training a computer vision model taking into account relevant visual parameters resulting from a (global) sensitivity analysis (and analyzed thereafter), in accordance with the present invention.

FIG. 6A schematically illustrates an example of a first training phase of a computer vision model, in accordance with the present invention.

FIG. 6B schematically illustrates an example of a second training phase of a computer vision model, in accordance with the present invention.

FIG. 7A schematically illustrates an example of a first implementation of a computer implemented calculation of a (global) sensitivity analysis of visual parameters, in accordance with the present invention.

FIG. 7B schematically illustrates an example of a second implementation of a computer implemented calculation of a (global) sensitivity analysis of visual parameters, in accordance with the present invention.

FIG. 8A schematically illustrates an example pseudocode listing for defining a world model of visual parameters and for a sampling routine, in accordance with the present invention.

FIG. 8B shows an example pseudocode listing for evaluating a sensitivity of a visual parameter, in accordance with the present invention.

FIG. 9 schematically illustrates an example computer-implemented method according to the second aspect of the present invention for characterising elements of observed scenes.

### DETAILED DESCRIPTION OF EXAMPLE EMBODIMENTS

Computer vision concerns with how computers can automatically gain high-level understanding from digital images or videos. In particular, computer vision may be applied in the automotive engineering field to detect road signs, and the instructions displayed on them, or obstacles around a vehicle. An obstacle may be a static or dynamic object capable of interfering with the targeted driving manoeuvre of the vehicle. Along the same lines, aiming at avoiding getting too close to an obstacle, an important application in the automotive engineering field is detecting a free space (e.g., the distance to the nearest obstacle or infinite distance) in the targeted driving direction of the vehicle, thus figuring out where the vehicle can drive (and how fast).

To achieve this, one, or more of object detection, semantic segmentation, 3D depth information, navigation instructions for autonomous system may be computed. Another common term used for computer vision is computer perception. In fact, computer vision can process inputs from any interaction between at least one detector 440a, 440b and its environment. The environment may be perceived by the at least one detector as a scene or a succession of scenes. In particular, interaction may result from at least one electromagnetic source (e.g. the sun) which may or may not be part of the environment. Detectors capable of capturing such electromagnetic interactions can e.g. be a camera, a multi-camera system, a RADAR or LIDAR system, or infra-red. An example of a non-electromagnetic interaction could be sound waves to be captured by at least one microphone to generate a sound map comprising sound levels for a plurality of solid angles, or ultrasound sensors.

Computer vision is an important sensing modality in automated or semi-automated driving. In the following specification, the term “autonomous driving” refers to fully autonomous driving, and also to semi-automated driving where a vehicle driver retains ultimate control and responsibility for the vehicle. Applications of computer vision in the context of autonomous driving and robotics are detection, tracking, and prediction of, for example:

drivable and non-drivable surfaces and road lanes, moving objects such as vehicles and pedestrians, road signs and traffic lights and potentially road hazards.

Computer vision has to deal with open context. It is not possible to experimentally model all possible visual scenes. Machine learning—a technique which automatically creates generalizations from input data may be applied to computer vision. The generalizations required may be complex, requiring the consideration of contextual relationships within an image.

For example, a detected road sign indicating a speed limit is relevant in a context where it is directly above a road lane that a vehicle is travelling in, but it might have less immediate contextual relevance if it is not above the road lane that the vehicle is travelling in.

Deep learning-based approaches to computer vision have achieved improved performance results on a wide range of benchmarks in various domains. In fact, some deep learning network architecture implement concepts such as attention, confidence, and reasoning on images. As industrial application of complex deep neural networks (DNNs) increases, there is an increased need for verification and validation (V&V) of computer vision models, especially in partly or fully automated systems where the responsibility for interaction between machine and environment is unsupervised. Emerging safety norms for automated driving, such as for example, the norm “Safety of the intended functionality” (SOTIF), may contribute to the safety of a CV-function.

Testing a computer vision function or qualitatively evaluating its performance is challenging because the input space of a typical input space for testing is large. Theoretically, the input space consists of all possible images defined by the combination of possible pixel values representing e.g. colour or shades of grey given the input resolution. However, creating images by random variation of pixel values will not produce representative images of the real world with a reasonable probability. Therefore, a visual dataset consists of real (e.g. captured experimentally by a physical camera) or synthetic (e.g. generated using 3D rendering, image augmentation, or DNN-based image synthesis) images or image sequences (videos) which are created based on relevant scenes in the domain of interest, e.g. driving on a road.

In industry, testing is often called verification. Even in a restricted input domain, the input space can be extremely large. Images (including videos) can e.g. be collected by randomly capturing the domain of interest, e.g. driving some arbitrary road and capturing images, or by capturing images systematically based on some attributes/dimensions/parameters in the domain of interest. While it is intuitive to refer to such parameters as visual parameters, it is not required that visual parameters relate to visibility with respect to the human perception system. It suffices that visual parameters relate to visibility with respect to one or more detectors.

One or more visual parameters define a visual state of a scene because it or they contain information about the contents of the observed scene and/or represent boundary conditions for capturing and/or generating the observed scene.

The visual parameters can be for example: camera properties (e.g. spatial- and temporal-sampling, distortion, aberration, colour depth, saturation, noise etc.), LIDAR or RADAR properties (e.g., absorption or reflectivity of surfaces, etc.), light conditions in the scene (light bounces, reflections, light sources, fog and light scattering, overall illumination, etc.), materials and textures, objects and their position, size, and rotation, geometry (of objects and environment), parameters defining the environment, environmental characteristics like seeing distance, precipitation-characteristics, radiation intensities (which are suspected to strongly interact with the detection process and may show strong correlations with performance), image characteristics/statistics (such as contrast, saturation, noise, etc.), domain-specific descriptions of the scene and situation (e.g. cars and objects on a crossing), etc. Many more parameters are possible.

These parameters can be seen as an ontology, taxonomy, dimensions, or language entities. They can define a restricted view on the world or an input model. A set of concrete images can be captured or rendered given an assignment/a selection of visual parameters, or images in an already existing dataset can be described using the visual parameters. The advantage of using an ontology or an input model is that for testing an expected test coverage target can be defined in order to define a test end-criterion, for example using t-wise coverage, and for statistical analysis a distribution with respect to these parameters can be defined.

Images, videos, and other visual data along with co-annotated other sensor data (GPS-data, radiometric data, local meteorological characteristics) can be obtained in different ways. Real images or videos may be captured by an image capturing device such as a camera system. Real images may already exist in a database and a manual or automatic selection of a subset of images can be done given visual parameters and/or other sensor data. Visual parameters and/or other sensor data may also be used to define required experiments. Another approach can be to synthesize images given visual parameters and/or other sensor data. Images can be synthesized using image augmentation techniques, deep learning networks (e.g., Generative Adversarial Networks (GANs), Variational Autoencoders (VAEs)), and 3D rendering techniques. A tool for 3D rendering in the context of driving simulation is for example the CARLA tool (Koltun, 2017, available at www.arXiv.org: 1711.03938).

Conventionally, in development and testing of computer vision functions, the input images are defined, selected, or generated based on properties (visual parameters) that seem important according to expert opinion. However, the expert opinion relating to the correct choice of visual parameters may be incomplete, or mislead by assumptions caused by the experience of human perception. Human perception is based on the human perception system (human eye and visual cortex), which differs from the technical characteristics of detection and perception using a computer vision function.

In this case the computer vision function (viz. computer vision model) may be developed or tested on image properties which are not relevant, and visual parameters which are important influence factors may be missed or underestimated. Furthermore, a technical system can detect additional characteristics as polarization, or extended spectral ranges that are not perceivable by the human perception system.

A computer vision model trained according to the method of the first aspect of this specification can analyze which parameter or characteristics show significance when testing, or statistically evaluating, a computer vision function. Given a set of visual parameters and a computer vision function as input, the technique outputs a sorted list of visual parameters (or detection characteristics). By selecting a sub list of visual parameters (or detection characteristics) from the sorted list, effectively a reduced input model (ontology) is defined.

In other words, the technique applies empirical experiments using a (global) sensitivity analysis in order to determine a prioritization of parameters and value ranges. This provides better confidence than the experts' opinion alone. Furthermore, it helps to better understand the performance characteristics of the computer vision function, to debug it, and develop a better intuition and new designs of the computer vision function.

From a verification-perspective, computer vision functions are often treated as a black-box. During development of a computer vision model, its design and implementation is done separately from the verification step. Therefore, conventionally verification concepts that would allow verifiability of the computer vision model are not integrated from the beginning.

Verification is thus often not the primary focus but the average performance. Another problem arises on the verification side. When treating the function as a black-box the test space is too large for testing.

A standard way to obtain computer vision is to train a computer vision model 16 based on a visual data set of the observed scenes and corresponding groundtruth.

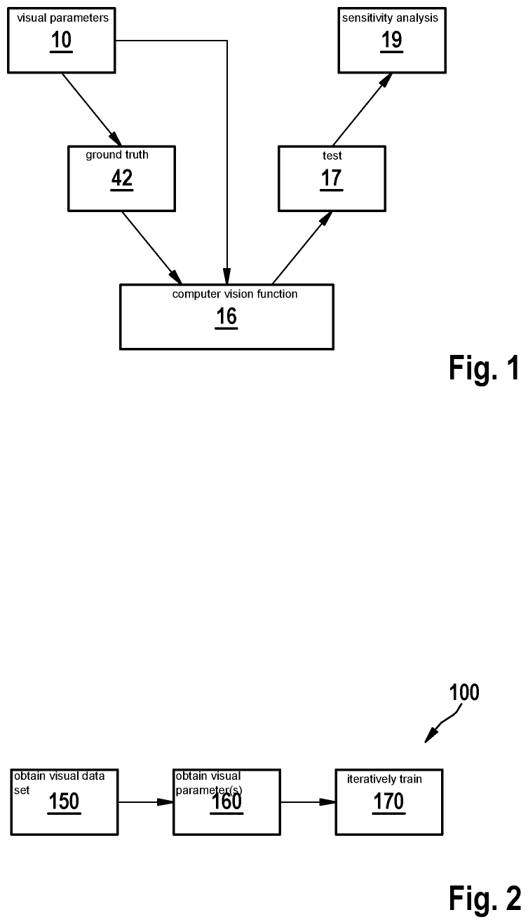

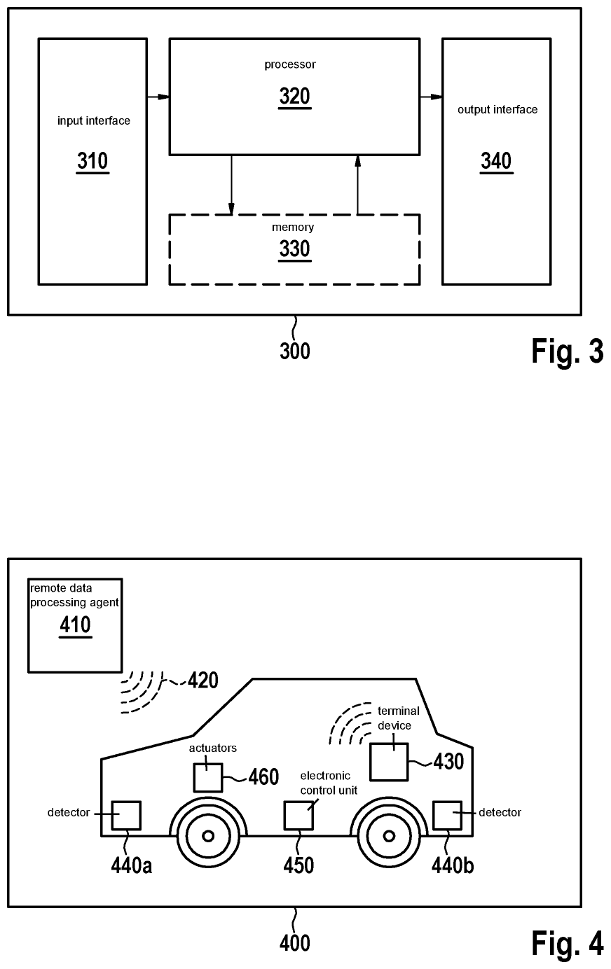

FIG. 1 schematically illustrates a development and verification process of a computer vision function. The illustrated model is applied in computer function development as the “V-model”.

Unlike in traditional approaches where development/design and validation/verification are separate tasks, according to the “V-model” development and validation/verification can be intertwined in that, in this example, the result from verification is fed back into the design of the computer vision function. A plurality of visual parameters 10 is used to generate a set of images and groundtruth (GT) 42. The computer vision function 16 is tested 17 and a (global) sensitivity analysis 19 is then applied to find out the most critical visual parameters 10, i.e., parameters which have the biggest impact on the performance 17 of the computer vision function. In particular, the CV-function 16 is evaluated 17 using the data 42 by comparing for each input image the prediction output with the groundtruth using some measure/metric thus yielding a performance score to be analyzed in the sensitivity analysis 19.

A first aspect relates to a computer-implemented method for training a computer vision model to characterise elements of observed scenes. The first method comprises obtaining 150 a visual data set of the observed scenes, and selecting from the visual data set a first subset of items of visual data, and providing a first subset of items of groundtruth data that correspond to the first subset of items of visual data, the first subset of items of visual data and the first subset of items of groundtruth data forming a training data set.

Furthermore, the first method comprises obtaining 160 at least one visual parameter or a plurality of visual parameters, with at least one visual parameter defining a visual state of at least one item of visual data in the training data set, wherein the visual state is capable of affecting a classification or regression performance of an untrained version of the computer vision model. For example, the visual parameters may be decided under the influence of an expert, and/or composed using analysis software.

Furthermore, the first method comprises iteratively training 170 the computer vision model based on the training data set, so as to render the computer vision model capable of providing a prediction of one or more elements within the observed scenes comprised in at least one subsequent item of visual data input into the computer vision model. During the iterative training 170, at least one visual parameter (i.e. a/the visual state of the at least one visual parameter) of the plurality of visual parameters is applied to the computer vision model, to thereby bias a subset of a latent representation of the computer vision model using the at least one visual parameter according to the visual state of the training data set input into the computer vision model during training.

Advantageously, the computer vision model is forced by training under these conditions to recognize the concept of the at least one visual parameter, and thus is capable of improving the accuracy of the computer vision model under different conditions represented by the visual parameters.

Advantageously, input domain design using higher-level visual parameters and a (global) sensitivity analysis of these parameters provide a substantial contribution of the verification of the computer vision model. According to the first aspect, the performance of the computer vision model under the influence of different visual parameters is integrated into the training of the computer vision model.

The core of the computer vision model is, for example, a deep neural network consisting of several neural net layers. However, other model topologies conventional to a skilled person may also be implemented according to the present technique. The layers compute latent representations which are higher-level representation of the input image. As an example, the specification proposes to extend an existing DNN architecture with latent variables representing the visual parameters which may have impact on the performance of the computer vision model, optionally according to a (global) sensitivity analysis aimed at determining relevance or importance or criticality of visual parameters. In so doing observations from verification are directly integrated into the computer vision model.

Generally, different sets of visual parameters (defining the world model or ontology) for testing or statistically evaluating computer vision function 16 can be defined and their implementation or exact interpretation may vary. This methodology enforces decision making based on empirical results 19, rather than experts' opinion alone and it enforces concretization 42 of abstract parameters 10. Experts must still provide visual parameters as candidates 10.

A visual data set of the observed scenes is a set of items representing either an image or a video, the latter being a sequence of images. Each item of visual data can be a numeric tensor with a video having an extra dimension for the succession of frames. An item of groundtruth data corresponding to one item of visual data is, for example a classification and/or regression result that the computer vision model should output in ideal conditions. For example, if the item of visual data is parameterized in part according to the presence of a wet road surface, and the presence, or not of a wet road surface is an intended output of the computer model to be trained, the groundtruth would return a description of that item of the associated item of visual data as comprising an image of a wet road.

Each item of groundtruth data can be another numeric tensor, or in a simpler case a binary result vector. A computer vision model is a function parametrized by model parameters that, upon training, can be learned based on the training data set using machine learning techniques. The computer vision model is configured to at least map an item of visual data to an item of predicted data. Items of visual data can be arranged (e.g. by embedding or resampling) so that it is well-defined to input them into the computer vision model 16. As an example, an image can be embedded into a video with one frame. One or more visual parameters define a visual state in that they contain information about the contents of the observed scene and/or represent boundary conditions for capturing and/or generating the observed scene. A latent representation of the computer vision model is an intermediate (i.e. hidden) layer or a portion thereof in the computer vision model.

FIG. 2 schematically illustrates a computer-implemented method according to the first aspect for training a computer vision model.

As an example, the visual data set is obtained in step 150. The plurality of visual parameters 10 is obtained in box 160. The order of steps 150 and 160 is irrelevant, provided that the visual data set of the observed scenes and the plurality of visual parameters 10 are compatible in the sense that for each item of the visual data set there is an item of corresponding groundtruth and corresponding visual parameters 10. Iteratively training the computer vision model occurs at step 170. Upon iterative training, parameters of the computer vision model 16 can be learned as in standard machine learning techniques by e g minimizing a cost function on the training data set (optionally, by gradient descent using backpropagation, although a variety of techniques are conventional to a skilled person).

In the computer-implemented method 100 of the first aspect, the at least one visual parameter is applied to the computer vision model 16 chosen, at least partially, according to a ranking of visual parameters resulting from a (global) sensitivity analysis performed on the plurality of visual parameters in a previous state of the computer vision model, and according to the prediction of one or more elements within an observed scene comprised in at least one item of the training data set.

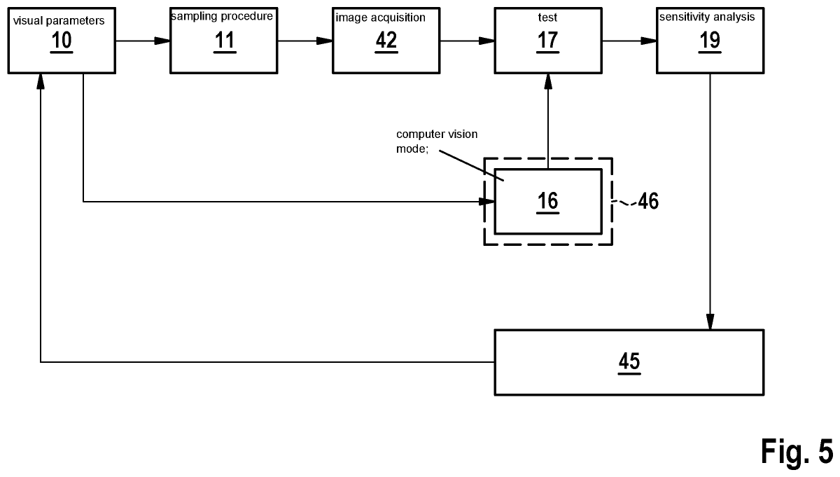

FIG. 5 schematically illustrates an example of a computer-implemented method for training a computer vision model taking into account relevant visual parameters resulting from a (global) sensitivity analysis.

As an example, a set of initial visual parameters and values or value ranges for the visual parameters in a given scenario can be defined (e.g. by experts). A simple scenario would have a first parameter defining various sun elevations relative to the direction of travel of the ego vehicle, although, as will be discussed later, a much wider range of visual parameters is possible.

A sampling procedure 11 generates a set of assignments of values to the visual parameters 10. Optionally, the parameter space is randomly sampled according to a Gaussian distribution. Optionally, the visual parameters are oversampled at regions that are suspected to define performance corners of the CV model. Optionally, the visual parameters are under sampled at regions that are suspected to define predictable performance of the CV model.

The next task is to acquire images in accordance with the visual parameter specification. A synthetic image generator, a physical capture setup and/or database selection 42 can be implemented allowing the generation, capture or selection of images and corresponding items of groundtruth according to the samples 11 of the visual parameters 10. Synthetic images are generated, for example, using the CARLA generator (e.g. discussed on https://carla.org). In the case of synthetic generation the groundtruth may be taken to be the sampled value of the visual parameter space used to generate the given synthetic image.

The physical capture setup enables an experiment to be performed to obtain a plurality of test visual data within the parameter space specified. Alternatively, databases containing historical visual data archives that have been appropriately labelled may be selected.

In a testing step 17, images from the image acquisition step 42 are provided to a computer vision model 16. Optionally, the computer vision model is comprised within an autonomous vehicle or robotic system 46. For each item of visual data input into the computer vision model 16, a prediction is computed and a performance score based, for example, on the groundtruth and the prediction is calculated. The result is a plurality of performance scores according to the sampled values of the visual parameter space.

A (global) sensitivity analysis 19 is performed on the performance scores with respect to the visual parameters 10. The (global) sensitivity analysis 19 determines the relevance of visual parameters to the performance of the computer vision model 16.

As an example, for each visual parameter, a variance of performance scores is determined. Such variances are used to generate and/or display a ranking of visual parameters. This information can be used to modify the set of initial visual parameters 10, i.e. the operational design domain (ODD).

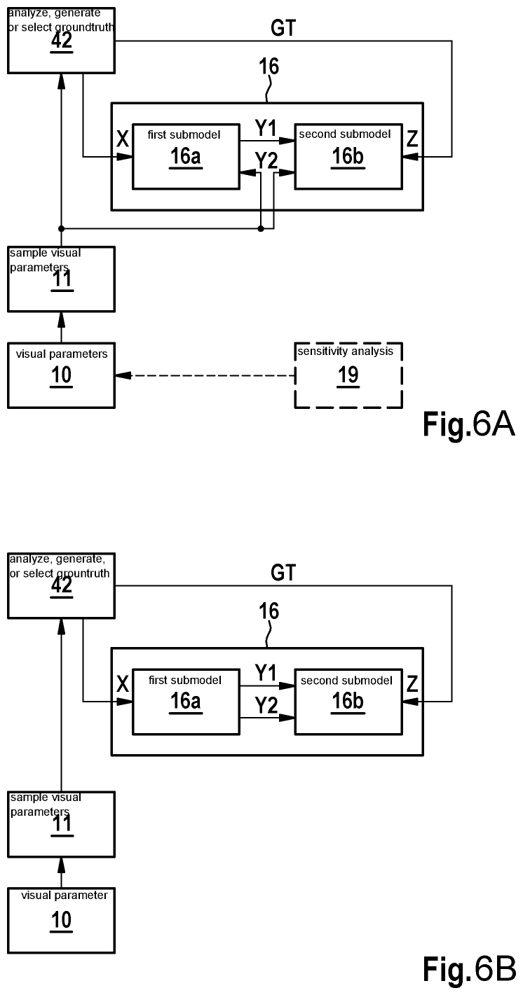

As an example, a visual parameter with performance scores having a lower variance can be removed from the set of visual parameters. Alternatively, another subset of visual parameters are selected. Upon retraining the computer vision model 16, the adjusted set of visual parameters are integrated as a latent representation into the computer vision model 16, see e.g. FIGS. 6A and 6B. In so doing, a robustness-enhanced computer vision model 16 is generated.

The testing step 17 and the (global) sensitivity analysis 19 and/or retraining the computer vision model 16 can be repeated. Optionally, the performance scores and variances of the performance score are tracked during such training iterations. The training iterations are stopped when the variances of the performance score appear to have settled (stopped changing significantly). In so doing, the effectiveness of the procedure is also evaluated. The effectiveness may also depend on factors such as a choice of the computer vision model 16, the initial selection of visual parameters 10, visual data and groundtruth capturing/generation/selection 42 for training and/or testing, overall amount, distribution and quality of data in steps 10, 11, 42, a choice of metrics or learning objective, the number of variables Y2 to eventually become another latent representation.

As an example, in case the effectiveness of the computer vision model can no longer be increased by retraining the computer vision model 16, changes can be made to the architecture of the computer vision model itself and/or to step 42. In some cases capturing and adding more real visual data corresponding to a given subdomain of the operational design domain before restarting the procedure or repeating steps therein can be performed.

When retraining, it can be useful to also repeat steps 10, 11, 42 to generate statistically independent items of visual data and groundtruth data. Furthermore, repeating steps 10, 11, 42 may be required to retrain the computer vision model 16 after adjusting the operational design domain.

In an embodiment, the computer vision model 16 comprises at least a first 16a and a second submodel 16b. The first submodel 16a outputs at least a first set Y1 of latent variables to be provided as a first input of the second submodel 16b. The first submodel 16a outputs at least a first set Y2 of variables that are provided to a second input of the second submodel 16b. Upon training, the computer vision model 16 can be parametrized to predict, for at least one item of visual data provided to the first submodel 16a, an item of groundtruth data output by the second submodel 16b.

As an example, a given deep neural network (DNN) architecture of the computer vision function can be partitioned into two submodels 16a and 16b. The first submodel 16a is extended to predict the values of the selected visual parameters 10, hence, the first submodel 16a is forced to become sensitive to these important parameters. The second submodel 16b uses these predictions of visual parameters from 16a to improve its output.

In an embodiment, iteratively training the computer vision model 16 comprises a first training phase, wherein from the training data set, or from a portion thereof, the at least one visual parameter for at least one subset of the visual data is provided to the second submodel 16b instead of the first set Y2 of variables output by the first submodel 16a. The first submodel 16a is parametrized so that the first set Y2 of variables output by the first submodel 16a predicts the at least one visual parameter for at least one item of the training data set.

In an embodiment, instead of, or in addition to visual parameters, the set Y2 of variables contains groundtruth data or a subset of groundtruth data or data derived from groundtruth such as a semantic segmentation map, an object description map, or a depth map. For example, 16a may predict Y1 and a depth map from the input image and 16b may use Y1 and the depth map to predict a semantic segmentation or object detection.

FIG. 6A schematically illustrates an example of a first training phase of a computer vision model. The example computer vision function architecture 16 contains, for example, a deep neural network which can be divided into at least two submodels 16a and 16b, where the output Y1 of the first submodel 16a can create a so-called latent representation that can be used by the second submodel 16b. Thus, first submodel 16a can have an item of visual data X as input and a latent representation Y1 as output, and second submodel 16b can have as input the latent representation Y1 and as output the desired prediction Z which aims at predicting the item of groundtruth GT data corresponding to the item of visual data.

From an initial set of visual parameters 10, also termed the operational design domain (ODD), visual parameters can be sampled 11 and items of visual data can be captured, generated or selected 42 according to the sampled visual parameters.

Items of groundtruth are analyzed, generated or selected 42. As far as the first set Y2 of variables is concerned, visual parameters function as a further item of groundtruth to train the first submodel 16a during the first training phase. The same visual parameters are provided as inputs Y2 of the second submodel 16b. This is advantageous because the Y2 output of the first submodel 16a and the Y2 input of the second submodel 16b are connected subsequently either in a second training phase (see below), or when applying the computer vision model 16 in a computer-implemented method 200 according to the second aspect for characterising elements of observed scenes (according to the second aspect). In fact, application of the computer vision model as in the method 200 is independent of the visual parameters.

Advantageously therefore, relevant visual parameters resulting from the (global) sensitivity analysis 19 are integrated as Y2 during the training of the computer vision model 16. The (global) sensitivity analysis 19 may arise from a previous training step based on the same training data set, or another statistically independent training data set. Alternatively, the (global) sensitivity analysis may arise from validating a pre-trained computer vision model 16 based on a validation data set that also encompasses items of visual data and corresponding items of groundtruth data, as well as on visual parameters.

The computer vision model 16 may comprise more than two submodels, wherein the computer vision model 16 results from a composition of these submodels. In such an architecture a plurality of hidden representations may arise between such submodels. Any such hidden representation can be used to integrate one or more visual parameters in one or more first training phases.

In an embodiment, iteratively training the computer vision model 16 may comprise a second training phase, wherein the first set Y2 of variables output by the first submodel 16a is provided to the second submodel 16b, optionally, wherein the computer vision model 16 is trained from the training data set or from a portion thereof without taking the at least one visual parameter into account, optionally, in the (global) sensitivity analysis performed on the plurality of visual parameters.

FIG. 6B schematically illustrates an example of a second training phase of a computer vision model.

The second training phase differs from the first training phase as illustrated in FIG. 6A because output Y2 of the first submodel 16a is now connected to input Y2 of the second submodel 16b. It is in this sense that visual parameters are not taken into account during the second training phase.

At the same time, Y2 variables have now become a latent representation. The second training phase can be advantageous in that training the first submodel 16a during the first training phase is often not perfect. In the rare but possible case that the first submodel 16a makes a false prediction on a given item of visual data, the second submodel 16b can also return a false prediction for the computer vision. This is because the second submodel 16b would not, in that case, have been able to learn to deal with wrong latent variables Y2 as input in the first training phase, because it has always been provided a true Y2 input (and not a prediction of Y2). In the second training phase, the computer vision model 16 can be adjusted to account for such artifacts if they occur. The second training phase can be such that integrating visual parameters as a latent representation of the computer vision model is not jeopardized. This can be achieved, for example, if the second training phase is shorter or involves fewer adjustments of parameters of the computer vision model, as compared to the first training phase.

In an embodiment, for each item in the training data set, a performance score can be computed based on a comparison between the prediction of one or more elements within the observed scenes, and the corresponding item of groundtruth data. The performance score may comprise one or any combination of: a confusion matrix, precision, recall, F1 score, intersection of union, mean average, and optionally wherein the performance score for each of the at least one item of visual data from the training data set can be taken into account during training. Performance scores can be used in the (global) sensitivity analysis, e.g. the sensitivity of parameters may be ranked according to the variance of performance scores when varying each visual parameter.

In an embodiment, the first submodel 16a can be a neural or a neural-like network, optionally a deep neural network and/or a convolutional neural network, and/or wherein the second submodel 16b can be a neural or a neural-like network, optionally a deep neural network and/or a convolutional neural network. A neural-like network can be e.g. a composition of a given number of functions, wherein at least one function is a neural network, a deep neural network or a convolutional neural network.

Furthermore, the visual data set of the observed scenes may comprise one or more of a video sequence, a sequence of stand-alone images, a multi-camera video sequence, a RADAR image sequence, a LIDAR image sequence, a sequence of depth maps, or a sequence of infra-red images. Alternatively, an item of visual data can, for example, be a sound map with noise levels from a grid of solid angles.

In an embodiment, the visual parameters may comprise one or any combination selected from the following list:
one or more parameters describing a configuration of an image capture arrangement, optionally an image or video capturing device, visual data is taken in or synthetically generated for, optionally, spatial and/or temporal sampling, distortion aberration, colour depth, saturation, noise, absorption;

one or more light conditions in a scene of an image/video, light bounces, reflections, reflectivity of surfaces, light sources, fog and light scattering, overall illumination; and/or
one or more features of the scene of an image/video, optionally, one or more objects and/or their position, size, rotation, geometry, materials, textures;
one or more parameters of an environment of the image/video capturing device or for a simulative capturing device of a synthetic image generator, optionally, environmental characteristics, seeing distance, precipitation characteristics, radiation intensity; and/or
image characteristics, optionally, contrast, saturation, noise;
one or more domain-specific descriptions of the scene of an image/video, optionally, one or more cars or road users, or one or more objects on a crossing.

In an embodiment, the computer vision model 16 may be configured to output at least one classification label and/or at least one regression value of at least one element comprised in a scene contained in at least one item of visual data. A classification label can for example refer to object detection, in particular to events like “obstacle/no obstacle in front of a vehicle” or free-space detection, i.e. areas where a vehicle may drive. A regression value can for example be a speed suggestion in response to road conditions, traffic signs, weather conditions etc. As an example, a combination of at least one classification label and at least one regression value would be outputting both a speed limit detection and a speed suggestion. When applying the computer vision model 16 (feed-forward), such output relates to a prediction. During training such output of the computer vision model 16 relates to the groundtruth GT data in the sense that on a training data set predictions (from feed-forward) shall be as close as possible to items of (true) groundtruth data, at least statistically.

According to the second aspect, a computer-implemented method 200 for characterising elements of observed scenes is provided. The second method comprises obtaining 210 a visual data set comprising a set of observation images, wherein each observation image comprises an observed scene. Furthermore, the second method comprises obtaining 220 a computer vision model trained according to the first method. Furthermore, the second method comprises processing 230 the visual data set using the computer vision model to thus obtain a plurality of predictions corresponding to the visual data set, wherein each prediction characterises at least one element of an observed scene. The method 200 of the second aspect is displayed in FIG. 9.

Advantageously, computer vision is enhanced using a computer vision model that has been trained to also recognize the concept of the at least one visual parameter. The second method can also be used for evaluating and improving the computer vision model 16, e.g. by adjusting the computer vision model and/or the visual parameters the computer vision model is to be trained on in yet another first training phase.

A third aspect relates to a data processing apparatus 300 configured to characterise elements of an observed scene. The data processing apparatus comprises an input interface 310, a processor 320, a memory 330 and an output interface 340. The input interface is configured to obtain a visual data set comprising a set of observation images, wherein each observation image comprises an observed scene, and to store the visual data set, and a computer vision model trained according to the first method, in the memory. Furthermore, the processor is configured to obtain the visual data set and the computer vision model from the memory. Furthermore, the processor is configured to process the visual data set using the computer vision model, to thus obtain a plurality of predictions corresponding to the set of observation images, wherein each prediction characterises at least one element of an observed scene. Furthermore, the processor is configured to store the plurality of predictions in the memory, and/or to output the plurality of predictions via the output interface.

In an example, the data processing apparatus 300 is a personal computer, server, cloud-based server, or embedded computer. It is not essential that the processing occurs on one physical processor. For example, it can divide the processing task across a plurality of processor cores on the same processor, or across a plurality of different processors. The processor may be a Hadoop™ cluster, or provided on a commercial cloud processing service. A portion of the processing may be performed on non-conventional processing hardware such as a field programmable gate array (FPGA), an application specific integrated circuit (ASIC), one or a plurality of graphics processors, application-specific processors for machine learning, and the like.

A fourth aspect relates to a computer program comprising instructions which, when executed by a computer, causes the computer to carry out the first method or the second method. A fifth aspect relates to a computer readable medium having stored thereon one or both of the computer programs.

The memory 330 of the apparatus 300 stores a computer program according to the fourth aspect that, when executed by the processor 320, causes the processor 320 to execute the functionalities described by the computer-implemented methods according to the first and second aspects. According to an example, the input interface 310 and/or output interface 340 is one of a USB interface, an Ethernet interface, a WLAN interface, or other suitable hardware capable of enabling the input and output of data samples from the apparatus 300. In an example, the apparatus 330 further comprises a volatile and/or non-volatile memory system 330 configured to receive input observations as input data from the input interface 310. In an example, the apparatus 300 is an automotive embedded computer comprised in a vehicle as in FIG. 4, in which case the automotive embedded computer may be connected to sensors 440a, 440b and actuators 460 present in the vehicle. For example, the input interface 310 of the apparatus 300 may interface with one or more of an engine control unit ECU 450 providing velocity, fuel consumption data, battery data, location data and the like. For example, the output interface 340 of the apparatus 300 may interface with one or more of a plurality of brake actuators, throttle actuators, fuel mixture or fuel air mixture actuators, a turbocharger controller, a battery management system, the car lighting system or entertainment system, and the like.

A sixth aspect relates to a distributed data communications system comprising a remote data processing agent 410, a communications network 420 (e.g. USB, CAN, or other peer-to-peer connection, a broadband cellular network such as 4G, 5G, 6G, . . . ) and a terminal device 430, wherein the terminal device is optionally an automobile or robot. The server is configured to transmit the computer vision model 16 according to the first method to the terminal device via the communications network. As an example, the remote data processing agent 410 may comprise a server, a virtual machine, clusters or distributed services.

In other words, a computer vision model is trained at a remote facility according to the first aspect, and is transmitted to the vehicle such as an autonomous vehicle, semi-autonomous vehicle, automobile or robot via a communications network as a software update to the vehicle, automobile or robot.

FIG. 4 schematically illustrates a distributed data communications system 400 according to the sixth aspect and in the context of autonomous driving based on computer vision. A vehicle may comprise at least one detector, preferably a system of detectors 440a, 440b, to capture at least one scene and an electronic control unit 450 where e.g. the second computer-implemented method 200 for characterising elements of observed scenes can be carried out.

Furthermore, 460 illustrates a prime mover such as an internal combustion engine or hybrid powertrain that can be controlled by the electronic control unit 450.

In general, sensitivity analysis (or, more narrower, global sensitivity analysis) can be seen as the numeric quantification of how the uncertainty in the output of a model or system can be divided and allocated to different sources of uncertainty in its inputs. This quantification can be referred to as sensitivity, or robustness. In the context of this specification, the model can, for instance, be taken to be the mapping,

Φ:X→Y

from visual parameters (or visual parameter coordinates) Xᵢ, i=1, . . . , n based on which items of visual data have been captured/generated/selected to yield performance scores (or performance score coordinates) Yⱼ, j=1, . . . , m based on the predictions and the groundtruth.

A variance-based sensitivity analysis, sometimes also referred to as the Sobol method or Sobol indices is a particular kind of (global) sensitivity analysis. To this end, samples of both input and output of the aforementioned mapping Φ can be interpreted in a probabilistic sense. In fact, as an example a (multi-variate) empirical distribution for input samples can be generated. Analogously, for output samples a (multi-variate) empirical distribution can be computed. A variance of the input and/or output (viz. of the performance scores) can thus be computed. Variance-based sensitivity analysis is capable of decomposing the variance of the output into fractions which can be attributed to input coordinates or sets of input coordinates. For example, in case of two visual parameters (i.e. n=2), one might find that 50% of the variance of the performance scores is caused by (the variance in) the first visual parameter (X₁), 20% by (the variance in) the second visual parameter (X₂), and 30% due to interactions between the first visual parameter and the second visual parameter. For n>2 interactions arise for more than two visual parameters. Note that if such interaction turns out to be significant, a combination between two or more visual parameters can be promoted to become a new visual dimension and/or a language entity. Variance-based sensitivity analysis is an example of a global sensitivity analysis.

Hence, when applied in the context of this specification, an important result of the variance-based sensitivity analysis is a variance of performance scores for each visual parameter. The larger a variance of performance scores for a given visual parameter, the more performance scores vary for this visual parameter. This indicates that the computer vision model is more unpredictable based on the setting of this visual parameter. Unpredictability when training the computer vision model 16 may be undesirable, and thus visual parameters leading to a high variance can be de-emphasized or removed when training the computer vision model.

In the context of this specification, the model can, for instance, be taken to be the mapping from visual parameters based on which items of visual data have been captured/generated/selected to yield performance scores based on the true and predicted items of groundtruth. An important result of the sensitivity analysis can be a variance of performance scores for each visual parameter. The larger a variance of performance scores for a given visual parameter, the more performance scores vary for this visual parameter. This indicates that the computer vision model is more unpredictable based on the setting of this visual parameter.

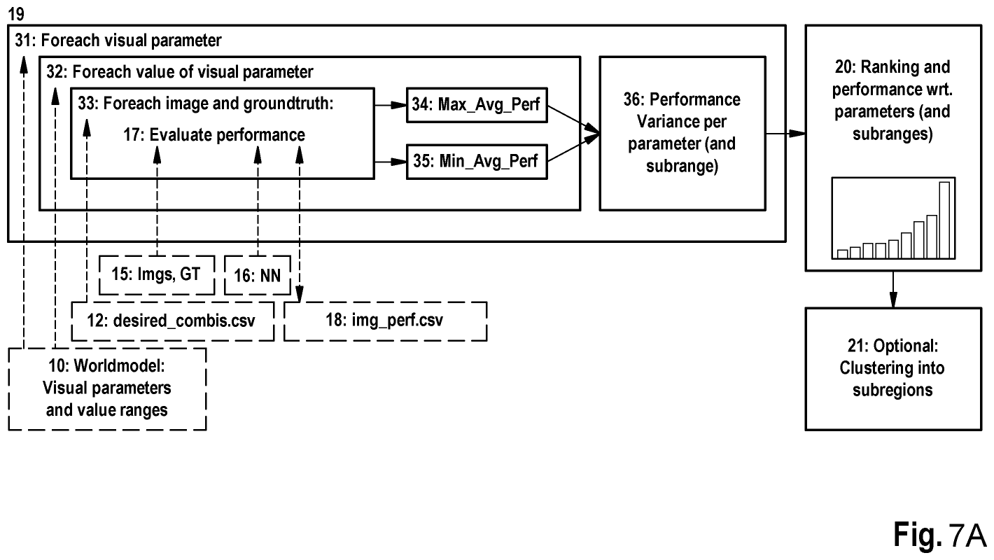

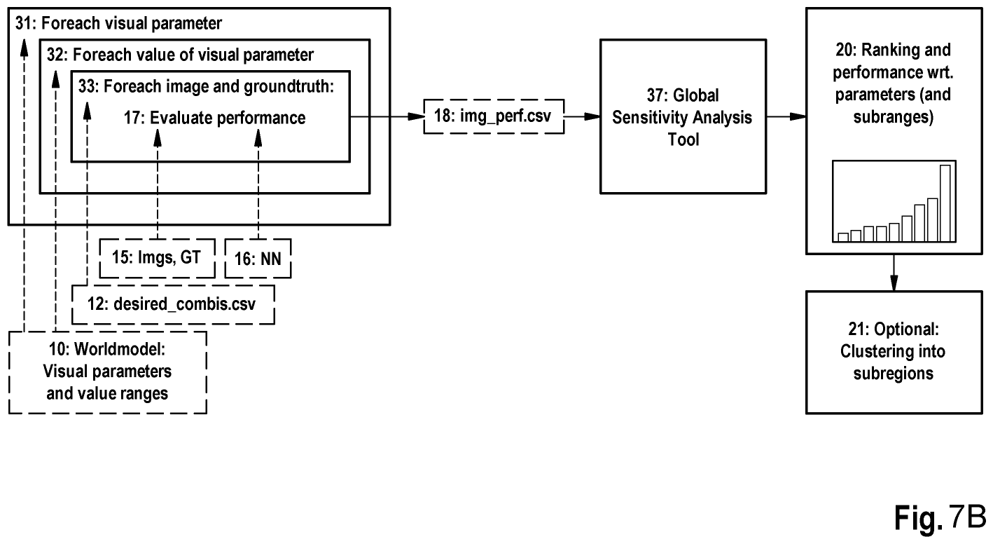

FIG. 7A schematically illustrates an example of a first implementation of a computer implemented calculation of a (global) sensitivity analysis of visual parameters.

FIG. 7B schematically illustrates an example of a second implementation of a computer implemented calculation of a (global) sensitivity analysis of visual parameters.

As an example, a nested loop is performed for each visual parameter 31, for each value of the current visual parameter 32, for each item of visual data and corresponding item of groundtruth 33 is captured, generated, and selected for the current value of the current visual parameter a prediction by 16 is obtained by e.g. applying the second method (according to the second aspect). In each such step, a performance score can be computed 17 based on the current item of groundtruth and the current prediction. In so doing the mapping from visual parameters to performance scores can be defined e.g. in terms of a lookup-table. It is possible and often meaningful to classify, group or cluster visual parameters e.g. in terms of subranges or combinations or conditions between various values/subranges of visual parameters. In FIG. 7A, a measure of variance of performance scores (viz. performance variance) can be computed based on arithmetic operations such as e.g. a minimum, a maximum or an average of performance scores within one class, group or cluster.

Alternatively, in FIG. 7B a (global) sensitivity analysis can be performed by using a (global) sensitivity analysis tool 37. As an example, a ranking of performance scores and/or a ranking of variance of performance scores, both with respect to visual parameters or their class, groups or clusters can be generated and visualized. It is by this means that relevance of visual parameters can be determined, in particular irrespective of the biases of the human perception system. Also adjustment of the visual parameters, i.e. of the operational design domain (ODD), can result from quantitative criteria.

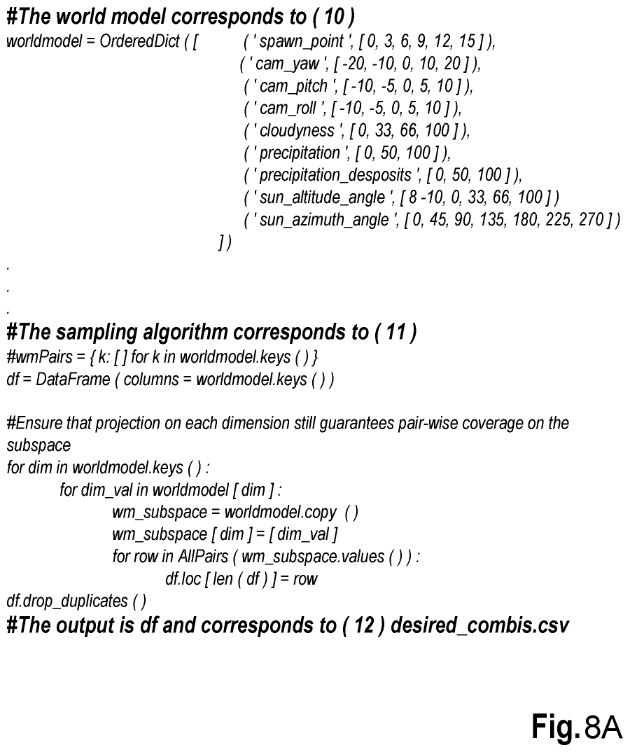

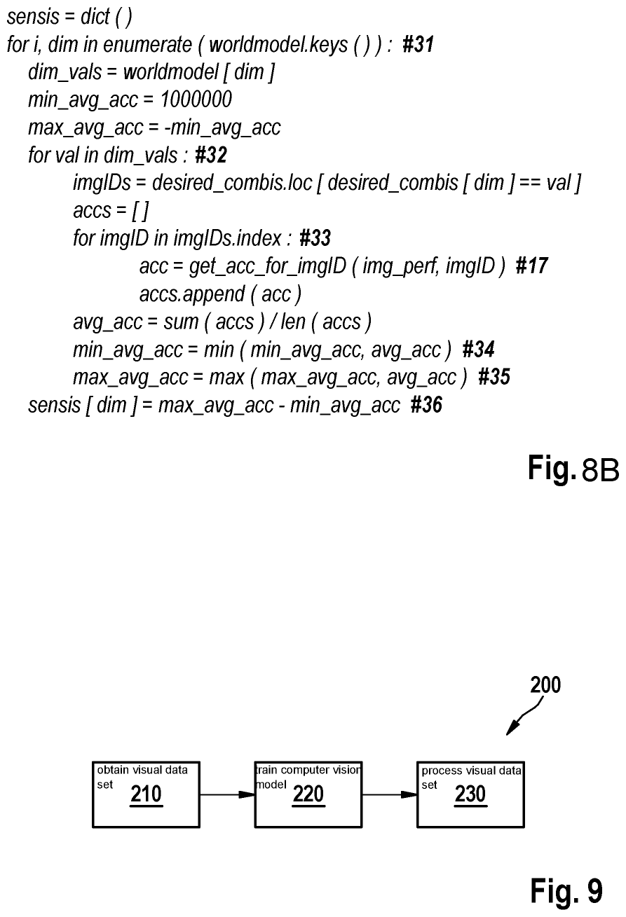

FIG. 8A schematically illustrates an example pseudocode listing for defining a world model of visual parameters and for a sampling routine. The pseudocode, in this example, comprises parameter ranges for a spawn point, a cam yaw, a cam pitch, a cam roll, cloudiness, precipitation, precipitation deposits, sun inclination (altitude angle), sun azimuth angle. Moreover an example implementation for a sampling algorithm 11 is shown (wherein Allpairs is a function in the public Python package “allpairspy”).

FIG. 8B shows an example pseudocode listing for evaluating a sensitivity of a visual parameter. In code lines (#)34, (#)35, (#)36 other arithmetic operations such as e.g. the computation of a standard deviation can be used.

The examples provided in the drawings and described in the foregoing written description are intended for providing an understanding of the principles of the present invention. No limitation to the scope of the present invention is intended thereby. The present specification describes alterations and modifications to the illustrated examples. Only the preferred examples have been presented, and all changes, modifications and further applications to these within the scope of the specification are desired to be protected.

What is claimed is:

1. A computer-implemented method for training a computer vision model to characterise elements of observed scenes, the method comprising the following steps:
obtaining a visual data set of the observed scenes;
selecting from the visual data set a first subset of items of visual data;
providing a first subset of items of groundtruth data that correspond to the first subset of items of visual data, the first subset of items of visual data and the first subset of items of groundtruth data forming a training data set;
obtaining visual parameters, each of the visual parameters defining a visual state of at least one item of visual data in the training data set, wherein the visual state is capable of affecting a classification or regression performance of an untrained version of the computer vision model; and
iteratively training the computer vision model based on the training data set, so as to render the computer vision model capable of providing a prediction of one or more elements within the observed scenes included in at least one subsequent item of visual data input into the computer vision model;
wherein, during the iterative training, at least one visual parameter of the visual parameters is applied to the computer vision model, to thereby bias a subset of a latent representation of the computer vision model using the at least one visual parameter according to the visual state of the training data set input into the computer vision model during training.

2. The computer-implemented method according to claim 1, wherein the at least one visual parameter is applied to the computer vision model chosen, at least partially, according to a ranking resulting from a sensitivity analysis performed on the visual parameters in a previous state of the computer vision model, and according to the prediction of one or more elements within an observed scene included in at least one item of the training data set.

3. The computer-implemented method according to claim 1, wherein:
the computer vision model includes at least a first submodel and a second submodel, the first submodel outputs at least a first set of latent variables to be provided as a first input of the second submodel, and the first submodel outputs at least a first set of variables that can be provided to a second input of the second submodel;
upon training, the computer vision model is parametrized to predict, for at least one item of visual data provided to the first submodel, an item of groundtruth data output by the second submodel, and/or instead of, or in addition to visual parameters, the set Y2 of variables contains groundtruth data or a subset of groundtruth data or data derived from groundtruth such as a semantic segmentation map, an object description map, or a depth map.

4. The computer-implemented method according to claim 3, wherein the iteratively training of the computer vision model includes a first training phase, in which from the training data set, or from a portion of the training data set the at least one visual parameter for at least one subset of the visual data is provided to the second submodel instead of the first set of variables output by the first submodel, and the first submodel is parametrized so that the first set of variables output by the first submodel predicts the at least one visual parameter for at least one item of the training data set.

5. The computer-implemented method according to claim 4, wherein the iteratively training of the computer vision model includes a second training phase, in which the first set of variables output by the first submodel is provided to the second submodel.

6. The computer-implemented method according to claim 5, wherein the computer vision model is trained from the training data set or from the portion of the training data set without taking the at least one visual parameter into account in the sensitivity analysis performed on the visual parameters.

7. The computer-implemented method according to claim 1, wherein for each item in the training data set, a performance score is computed based on a comparison between the prediction of one or more elements within the observed scenes, and the corresponding item of groundtruth data, and wherein the performance score includes one or any combination of: a confusion matrix, a precision, a recall, a F1 score, an intersection of union, a mean average.

8. The computer-implemented method according to claim 7, wherein the performance score for each of the at least one item of visual data from the training data set is taken into account during training.

9. The computer-implemented method according to claim 3, wherein: (i) the first submodel is a neural or a neural-like network and/or a deep neural network and/or a convolutional neural network, and/or (ii) the second submodel is a neural or a neural-like network and/or a deep neural network and/or a convolutional neural network.

10. The computer-implemented method according to claim 1, wherein the visual data set of the observed scenes includes one or more of a video sequence, or a sequence of stand-alone images, or a multi-camera video sequence, or a RADAR image sequence, or a LIDAR image sequence, or a sequence of depth maps, or a sequence of infra-red images.

11. The computer-implemented method according to claim 1, wherein the visual parameters include one or any combination selected from the following list:
one or more parameters describing a configuration of an image capture arrangement, and/or an image or video capturing device, or visual data is taken in or synthetically generated for spatial and/or temporal sampling, and/or distortion aberration, and/or colour depth, and/or saturation, and/or noise, and/or absorption, and/or reflectivity of surfaces; and/or
one or more light conditions in a scene of an image/video, and/or light bounces, and/or reflections, and/or light sources, and/or fog and light scattering, and/or overall illumination; and/or
one or more features of a scene of an image/video, and/or one or more objects and/or their position, and/or size, and/or rotation, and/or geometry, and/or materials, and/or textures; and/or
one or more parameters of an environment of the image/video capturing device or for a simulative capturing device of a synthetic image generator, and/or environmental characteristics, and/or seeing distance, and/or precipitation characteristics, and/or radiation intensity; and/or
image characteristics, and/or contrast, and/or saturation, and/or noise; and/or
one or more domain-specific descriptions of the scene of an image/video, and/or one or more cars or road users, and/or one or more objects on a crossing.

12. The computer-implemented method according to claim 1, wherein the computer vision model is configured to output at least one classification label and/or at least one regression value of at least one element included in a scene contained in at least one item of visual data.

13. A computer-implemented method for characterising elements of observed scenes, comprising the following steps:
obtaining a visual data set including a set of observation images, wherein each observation image includes an observed scene;
obtaining a computer vision model trained by:
obtaining a first visual data set of the observed scenes;
selecting from the first visual data set a first subset of items of visual data;
providing a first subset of items of groundtruth data that correspond to the first subset of items of visual data, the first subset of items of visual data and the first subset of items of groundtruth data forming a training data set;
obtaining visual parameters, each of the visual parameters defining a visual state of at least one item of visual data in the training data set, wherein the visual state is capable of affecting a classification or regression performance of an untrained version of the computer vision model; and
iteratively training the computer vision model based on the training data set, so as to render the computer vision model capable of providing a prediction of one or more elements within the observed scenes included in at least one subsequent item of visual data input into the computer vision model;
wherein, during the iterative training, at least one visual parameter of the visual parameters is applied to the computer vision model, to thereby bias a subset of a latent representation of the computer vision model using the at least one visual parameter according to the visual state of the training data set input into the computer vision model during training; and
processing the visual data set using the computer vision model to obtain a plurality of predictions corresponding to the visual data set, wherein each prediction characterises at least one element of an observed scene.

14. A data processing apparatus configured to characterise elements of an observed scene, comprising:
an input interface;
a processor;
a memory; and
an output interface;
wherein the input interface is configured to obtain a visual data set including a set of observation images, wherein each observation image comprises an observed scene, and to store the visual data set, and a computer vision model in the memory, the computer vision model being trained by:
obtaining a first visual data set of the observed scenes;
selecting from the first visual data set a first subset of items of visual data;
providing a first subset of items of groundtruth data that correspond to the first subset of items of visual data, the first subset of items of visual data and the first subset of items of groundtruth data forming a training data set;
obtaining visual parameters, each of the visual parameters defining a visual state of at least one item of visual data in the training data set, wherein the visual state is capable of affecting a classification or regression performance of an untrained version of the computer vision model; and
iteratively training the computer vision model based on the training data set, so as to render the computer vision model capable of providing a prediction of one or more elements within the observed scenes included in at least one subsequent item of visual data input into the computer vision model;
wherein, during the iterative training, at least one visual parameter of the visual parameters is applied to the computer vision model, to thereby bias a subset of a latent representation of the computer vision model using the at least one visual parameter according to the visual state of the training data set input into the computer vision model during training;
wherein the processor is configured to obtain the visual data set and the computer vision model from the memory; and
wherein the processor is configured to process the visual data set using the computer vision model, to obtain a plurality of predictions corresponding to the set of observation images,
wherein each prediction characterises at least one element of an observed scene, and
wherein the processor is configured to store the plurality of predictions in the memory, and/or to output the plurality of predictions via the output interface.

15. A non-transitory computer readable medium on which is stored a computer program for training a computer vision model to characterise elements of observed scenes, the computer program, when executed by a processor, causing the processor to perform the following steps:
obtaining a visual data set of the observed scenes;
selecting from the visual data set a first subset of items of visual data;
providing a first subset of items of groundtruth data that correspond to the first subset of items of visual data, the first subset of items of visual data and the first subset of items of groundtruth data forming a training data set;
obtaining visual parameters, each of the visual parameters defining a visual state of at least one item of visual data in the training data set, wherein the visual state is capable of affecting a classification or regression performance of an untrained version of the computer vision model; and
iteratively training the computer vision model based on the training data set, so as to render the computer vision model capable of providing a prediction of one or more elements within the observed scenes included in at least one subsequent item of visual data input into the computer vision model;
wherein, during the iterative training, at least one visual parameter of the visual parameters is applied to the computer vision model, to thereby bias a subset of a latent representation of the computer vision model using the at least one visual parameter according to the visual state of the training data set input into the computer vision model during training.

16. A distributed data communications system, comprising:
a data processing agent;
a communications network; and
a terminal device, wherein the terminal device is an autonomous vehicle or a semi-autonomous vehicle or an automobile or a robot;
wherein the data processing agent is configured to transmit s computer vision model to the terminal device via the communications network, wherein the computer vision model is trained to characterise elements of observed scenes by:
obtaining a visual data set of the observed scenes;
selecting from the visual data set a first subset of items of visual data;
providing a first subset of items of groundtruth data that correspond to the first subset of items of visual data, the first subset of items of visual data and the first subset of items of groundtruth data forming a training data set;
obtaining visual parameters, each of the visual parameters defining a visual state of at least one item of visual data in the training data set, wherein the visual state is capable of affecting a classification or regression performance of an untrained version of the computer vision model; and
iteratively training the computer vision model based on the training data set, so as to render the computer vision model capable of providing a prediction of one or more elements within the observed scenes included in at least one subsequent item of visual data input into the computer vision model;
wherein, during the iterative training, at least one visual parameter of the visual parameters is applied to the computer vision model, to thereby bias a subset of a latent representation of the computer vision model using the at least one visual parameter according to the visual state of the training data set input into the computer vision model during training.
